(19) United States
(12) Patent Application Publication
(10) Pub. No.: US 2007/0224145 A1
(43) Pub. Date: Sep. 27, 2007

(54) Thickened Hair-Treatment Agent Containing Water Glass

(76) Inventors: Andrea Walter, Buettelborn (DE); Manuela Hannich, Egelsbach (DE); Susanne Birkel, Darmstadt (DE); Axel Kalbfleisch, Darmstadt (DE)

Correspondence Address: MICHAEL J. STRIKER, 103 EAST NECK ROAD, HUNTINGTON, NY, 11743, US

(21) Appl. No.: 10/579,479

(22) PCT Filed: Oct. 23, 2004
(86) PCT No.: PCT/EP04/12016

§ 371 Date: Jan. 11, 2007

(30) Foreign Application Priority Data
Nov. 19, 2003 (DE) 103 54 015.6

(51) Int. Cl. A61Q 5/06

(52) U.S. Cl. 424/70.6; 424/70.11; 424/70.15; 424/70.16; 424/70.17

(57) ABSTRACT

Described is a hair-treatment agent in the form of a thickened preparation on an aqueous basis and containing at least one polymeric gel former bearing acid groups, water glass in an amount sufficient for partly or completely neutralizing the acid groups of the polymeric gel former and at least one hair-fixing polymer.

The invention has for an object a hair-treatment agent in thickened form on an aqueous basis and containing at least one polymeric gel former bearing acid groups, water glass in an amount sufficient for partial or complete neutralization of the acid groups of the polymeric gel former and at least one hair-fixing polymer.

Hair gels are used to give human hair firmness and hold. Common hair gels as a rule contain a combination of gel formers and hair-fixing polymers. In aqueous, alcoholic or aqueous-alcoholic media, the cosmetic, hair-fixing polymers usually employed for this purpose show good fixing properties which after use more or less effectively hold and firm up the hair. The commonly used gel formers are often anionic polymers, namely polymers containing acid groups, the thickening action in aqueous systems being brought about by neutralization of the acid groups with appropriate neutralizing agents. As a rule, the commonly used neutralizing agents allow no major variations in terms of unusual product consistencies and rheological properties. They often also exert a deleterious effect on other, desired properties of a hair gel. They can in an undesirable manner affect the fixing efficacy, the application properties, for example the distributability or incorporability into the hair, or the hair properties, for example the luster or feel, or because of incompatibilities they can prevent the use of otherwise desirable other constituents.

The neutralizing agents most frequently used in styling gels are organic amines or inorganic hydroxides. The said agents either have the drawback that they are highly volatile and have an undesirable inherent odor, for example ammonia, ethanolamine or aminomethylpropanol (AMP), or the neutralizing agents, for example ammonia, or alkali metal hydroxides such as sodium or potassium hydroxide, affect the quality of the polymer film in an undesirable manner. The films then are not sufficiently flexible, and the hair has an unnatural feel. The use of nonvolatile, higher-molecular-weight amines never entirely eliminates an undesirable inherent odor due to impurities in the form of highly volatile amines introduced during preparation. Some amines have an irritating effect on the skin or insufficient color stability or they can be contaminated with N-nitrosamines which are objectionable from a health standpoint. Moreover, a general difficulty lies in making sure that the desired viscosity remains sufficiently stable also during prolonged storage at elevated temperatures (for example at 40 to 50° C.). One of the neutralizing agents most frequently used to date is AMP, because it offers an acceptable compromise between positive and negative properties. In the case of AMP, however, one is limited with respect to rheological properties, product consistency and application properties on the hair. With AMP and similar neutralizing agents, a fundamental variation in product consistency and rheological properties is not readily attainable.

Hence, our goal was to find an alternative neutralizing agent for styling gels based on anionic thickeners and which would, on the one hand, offer the possibility of broader variation of achievable product consistencies and, on the other, would have as few or none of the afore-said drawbacks. In particular, the goal was to provide a hair gel with a low inherent odor and which at the same time would have good application properties on the hair (distributability, fixing, strand definition etc) and, in addition, would exhibit attractive, unusual haptic and/or Theological properties. We have now found that this objective can be reached by use of water glass. In this case, water glass can be used as the only neutralizing agent or in combination with at least one other neutralizing agent.

The invention has for an object a hair-treatment agent containing

(A) at least one polymeric gel former bearing acid groups,

(B) water glass,

(C) at least one hair-fixing polymer and

(D) water, the hair-treatment agent being in the form of a thickened preparation.

The thickened preparation can have different consistencies, namely it can be gel-like, crumbly or pudding-like. The acid groups of the polymeric gel former (A) are at least partly but preferably completely neutralized by the water glass.

Water glass is the designation for glassy, water-soluble potassium and/or sodium silicates (salts of silicic acid) that have solidified from the melt or for their viscous aqueous solutions. Water glass is made up of 2 to 4 molecules of SiO₂ per molecule of alkali metal oxide for which reason sodium and potassium water glass are usually characterized by their SiO₂/alkali metal oxide weight ratio or molar ratio and by the density of the aqueous solution. Such solutions because of hydrolysis contain mainly hydrogen salts such as M₃H₁SiO₄, M₂H₂SiO₄ and MH₃SiO₄ (where M=or Na). In the pure state, the water glasses are transparent and colorless. The commercial products are colored by traces of iron to bluish to greenish or to yellowish to brown materials which with water at an elevated temperature and pressure form colloidal, clear, strongly alkaline solutions. Water glass can be prepared by melting together quartz sand and sodium carbonate or potassium carbonate at 1400-1500° C. with elimination of CO₂. The solidified melt is marketed either in the ground state or in the form of an aqueous solution having a desired concentration. According to the invention, sodium water glass is preferred.

In the hair-treatment agent of the invention, the polymeric gel formers in component (A) can be partly or completely neutralized by the water glass of component (B). Preferred are agents wherein the acid groups in the polymeric gel former of component (A) are neutralized by the water glass of component (B) to an extent of 50 to 100% or 80 to 90%. Additional neutralization can be brought about with an additional co-neutralizing agent. Suitable co-neutralizing agents are, for example, primary or secondary amines, particularly aminoalkanols, preferably with 1 to 10 carbon atoms and with 1 to 3 hydroxyl group, for example aminomethylpropanol (AMP), triethanolamine, tetrahydroxypropylethylenediamine, diethanolamine or monoethanolamine, as well as ammonia, NaOH, KOH and the like. The agents of the invention, however, are preferably free of co-neutralizing agents or contain these in smaller amounts than the water glass.

The amount of water glass and optionally of other neutralizing agents is preferably selected so that the pH is in the range of about 5 to 8.5 and particularly 5.5 to 8 or 6 to 7.5.

Polymeric Gel Formers

The polymeric gel former (A) is preferably used in an amount from 0.01 to 10 wt. % and particularly from 0.1 to 5 wt. % or from 0.5 to 3 wt. %.

Suitable as polymeric gel formers are synthetic homopolymers or copolymers of at least one monomer that contains at least one acid group, preferably a carboxylic acid, sulfonic acid or phosphoric acid group. Also suitable are polymers of a natural origin, particularly polysaccharides with at least one kind of saccharide containing at least one acid group, for example glucuronic acid.

Suitable synthetic gel formers are derived, for example, from at least one kind of monomer selected from among acrylic acid, methacrylic acid, itaconic acid monoesters, acrylamidoalkylsulfonic acids, and/or methacrylamidoalkylsulfonic acids. Suitable synthetic gel formers are, for example: crosslinked or noncrosslinked homopolymers of acrylic acid (carbomers) with a molecular weight of, for example, 2,000,000 to 6,000,000 (such gel formers are commercially available under the designation Carbopol®), copolymers of acrylic acid and acrylamide, for example with a molecular weight of 2,000,000 to 6,000,000, acrylate/Steareth-20 methacrylate copolymer, copolymers of acrylic or methacrylic acid and acrylate esters or methacrylate esters (acrylate copolymers), acrylates/C₁₀₋₃₀ alkyl acrylate cross-polymer, acrylate/vinyl alcohol copolymers, polystyrenesulfonic acid and mixtures thereof.

Suitable gel formers of natural origin are natural or modified natural polymers, for example: alginic acid, carragheenan, carboxymethylcellulose, carboxymethylhydroxyethylcellulose, carboxymethyldextran, carboxymethylhydroxypropylguar, cellulose sulfate, dextran sulfate, karaya gum, xanthan gum and mixtures thereof.

Suitable gel formers are in particular the homopolymers or copolymers derived from at least one ethylenically unsaturated monomer of general formula (I) CH₂═CR¹R² wherein R¹ is selected from among A-(CH₂CH₂O)ₓR³and COOH, A is selected from among C(═O)O, C(═O)NH and CH₂O, x is a numeral from 1 to 100 and preferably from 10 to 50, R³ denotes a C₁-C₃₀-alkyl group, preferably a C₈-C₃₀-alkyl group, R² is selected from among H, C₁-C₃₀-alkyl and CH₂—R¹, provided that at least one of the R¹ and R² groups contains the A-(CH₂CH₂O)ₓR₃ group. Suitable copolymers are derived, for example, from at least one ethylenically unsaturated monomer of general formula (I) and at least one ethylenically unsaturated monomer of general formula (II) CH₂═C(R⁴)COOR⁵ wherein R₄ and R₅ independently of each other are selected from among H and an alkyl group with 1 to 30, particularly 1 to 12 and especially 1 to 4 carbon atoms. Preferably, A is selected from among C(═O)O and CH₂O, R² is selected from among H and methyl, or the monomer of formula (I) is an itaconic acid derivative. It is also preferred that the monomer of formula (II) be acrylic acid, methacrylic acid or one the C₁-C₄-alkyl esters thereof.

Suitable copolymers, for example, are the copolymers of acrylic or methacrylic acid/polyethoxyalkyl esters of acrylic or methacrylic acid (INCI designations: acrylates/Steareth-20 methacrylate copolymer, acrylate/Palmeth-25 acrylate copolymer) marketed under the designations Acrysol® -22, Acrysol® ICS, Aculyn®-22 or Synthalen® W-2000, or the copolymers of acrylic or methacrylic acid/polyethoxyalkylallyl ethers (INCI designation: Steareth-10 allyl ether/acrylates copolymer) marketed under the designation Saicare® SC 90.

Suitable gel formers are, for example, the copolymers derived from a monoester of itaconic acid of general formula CH₂═C(COOR¹)CH₂COOR² wherein one of the R¹ and R2 substituents denotes hydrogen and the other denotes the —(CH₂CH₂O)ₓ—R³ group; x is a numeral from 1 to 100, preferably from 10 to 40 and most preferably equal to 20; R³ is an alkyl group with 8 to 30 and preferably 12 to 20 carbon atoms, more preferably cetyl or stearyl, and from at least a second kind of monomer selected from among the acrylate monomers. The acrylate monomers are preferably selected from among acrylic acid, methacrylic acid and the simple esters thereof, particularly the alkyl acrylate esters and alkyl methacrylate esters with 1 to 10 and preferably 1 to 4 carbon atoms in the alkyl group. Suitable copolymers are, for example, the copolymers of acrylic acid or methacrylic acid/polyethoxyalkyl esters of itaconic acid (INCI designations: acrylates/-Steareth-20 itaconate copolymer and acrylates/Ceteth-20 itaconate copolymer, acrylates/aminoacrylates/C₁₀-C₃₀-alkyl PEG-20 itaconate copolymer. Ceteth-10 itaconate copolymer) is marketed, for example, under the designations Structure® 2001, Structure® 3001 and Structure® Plus.

Suitable gel formers are also the homopolymers and copolymers derived from at least one kind of monomer selected from among acrylamidoalkylsulfonic acid or methacrylamidoalkylsulfonic acid. The polymer is preferably derived from a monomer of general formula H₂C═CH—C(═O)—NH-A-SO₃H wherein A denotes a divalent C₂ to C₆ and preferably a C₃ or C₄ hydrocarbon group, the —C(CH₃)₂—CH₂-group being particularly preferred. This monomer is preferably copolymerized with at least one nonionic, free radical-copolymerizable monomer, particularly a vinyllactam and most preferably vinylpyrrolidone. Such a gel former, for example, has the INCI designation ammonium acryloyldimethyltaurate/NP copolymer. A suitable commercial product is Aristoflex® AVC.

Additionally, the agent of the invention can contain as co-thickener nonpolymeric and/or nonionic polymeric thickeners, for example hydroxyethylcellulose.

Hair-Fixing Polymers

The hair-fixing polymer (C) is preferably used in an amount from 0.1 to 20 wt. % and particularly from 0.5 to 15 wt. % or from 1 to 10 wt. %.

The hair-fixing polymer (C) can be nonionic, anionic, cationic, zwitterionic or amphoteric. It can be a synthetic or natural polymer. By natural polymers are also meant chemically modified polymers of natural origin. Particularly preferred are polymers having sufficient solubility in water, alcohol or water/alcohol mixtures so that in the agent of the invention they are present in completely dissolved form. By hair-fixing polymers are meant according to the invention polymers which when used in a 0.01 to 5% aqueous, alcoholic or aqueous-alcoholic solution or dispersion are capable of exerting a fixing action on the hair, namely of stabilizing a formed hairdo.

Suitable synthetic, nonionic hair-fixing polymers are the homopolymers or copolymers derived from at least one of the following monomers: vinylpyrrolidone, vinylcaprolactam, vinyl esters, for example vinyl acetate, vinyl alcohol, acrylamide, methacrylamide, alkylacrylamide and dialkylacrylamide, alkylmethacrylamide and dialkylmethacrylamide, dialkylaminoalkylmethacrylamide, dialkylaminoalkylacrylamide, alkyl acrylate, alkyl methacrylate, propylene glycol or ethylene glycol, the alkyl groups of these monomers preferably being C₁- to C₇-alkyl groups and most preferably C₁- to C₃-alkyl groups. Suitable are, for example, the homopolymers of vinylcaprolactam, vinylpyrrolidone or N-vinylformamide. Other suitable hair-fixing polymers are, for example, the copolymers of vinylpyrrolidone and vinyl acetate, the terpolymers of vinylpyrrolidone, vinyl acetate and vinyl propionate, the terpolymers of vinylpyrolidone, vinyl caprolactam and dialkylaminoalkyl (meth)acrylate, the terpolymers of vinylpyrrolidone, vinylcaprolactam and dialkylaminoalkyl(meth)acrylamide, polyacrylamide, polyvinyl alcohols, and the hair-fixing polyethylene glycol/polypropylene glycol copolymers. Particularly preferred nonionic polymers are polyvinylpyrrolidone and polyvinylpyrrolidone/vinyl acetate copolymers. Preferred are the nonionic vinyllactam homopolymers or copolymers. Suitable vinyllactams are, for example, vinylcaprolactam and vinylpyrrolidone. Particularly preferred are polyvinylpyrrolidone, polyvinylcaprolactam and vinylpyrrolidone/vinyl acetate copolymers. Commercial products are, for example, Luviskol® VA 37 and Luviskol® VA 64.

Suitable anionic hair-fixing polymers are natural or synthetic homopolymers or copolymers with acid groups-containing monomer units which optionally are copolymerized with comonomers that do not contain an acid group. The acid groups are preferably selected from among —COOH, —SO₃H, —OSO₃H, —OPO₂H and —OPO₃H₂ among which the carboxylic acid groups are preferred. The acid groups can be unneutralized, partly neutralized or completely neutralized. Preferably they are up to 50 to 100% in anionic or neutralized form. The above-said neutralizing agents can be used for neutralization. Suitable monomers are the unsaturated, free-radical-copolymerizable compounds containing at least one acid group, particularly the carboxyvinyl monomers. Suitable acid-groups-containing monomers are, for example, acrylic acid, methacrylic acid, crotonic acid, maleic acid or maleic anhydride or the monoesters thereof, aldehydocarboxylic acids or ketocarboxylic acids.

Comonomers devoid of acid group substitution are, for example, acrylamide, methacrylamide, alkylacrylamide and dialkylacrylamide, alkylmethacrylamide and dialkylmethacrylamide, alkyl acrylate, alkyl methacrylate, vinylcaprolactone, vinylpyrrolidone, vinyl esters, vinyl alcohol, propylene glycol or ethylene glycol, amine-substituted vinyl monomers, for example dialkylaminoalkyl acrylate, dialkylaminoalkyl methacrylate, monoalkylaminoalkyl acrylate and monoalkylaminoalkyl methacrylate, the alkyl groups of these monomers preferably being C₁ to C₇-alkyl group and most preferably C₁- to C₃-alkyl groups.

Suitable anionic polymers [different from component (A)] are, in particular, the copolymers of acrylic acid or methacrylic acid with monomers selected from among the esters of acrylic acid or methacrylic acid, acrylamides, methacrylamides and vinylpyrrolidone, the homopolymers of crotonic acid and copolymers of crotonic acid with monomers selected from among the vinyl esters, esters of acrylic or methacrylic acid, acrylamides and methacrylamides. A suitable natural polymer is, for example, shellac.

Preferred anionic polymers are the crosslinked or uncrosslinked vinyl acetate/crotonic acid copolymers. Also preferred are the partly esterified copolymers of vinyl methyl ether and maleic anhydride. Other suitable anionic polymers are, for example, the terpolymers of acrylic acid, alkyl acrylate and N-alkylacrylamide, particularly the acrylic acid/ethyl acrylate /N-t-butylacrylamide terpolymers or the terpolymers of vinyl acetate, crotonate and vinyl alkanoate, especially the vinyl acetate/crotonate/vinyl neodecanoate copolymers.

Suitable film-forming amphoteric polymers are polymers which besides acid or anionic groups contain other functional groups such as basic or cationic groups, particularly primary, secondary, tertiary or quatemary amino groups. Examples of these are the copolymers derived from alkylacrylamide (particularly octylacrylamide), alkylaminoalkyl methacrylate (particularly t-butylaminoethyl methacrylate) and two or more monomers selected from among acrylic acid, methacrylic acid or the esters thereof, the alkyl groups containing at least 1 to 4 carbon atoms, and at least one of the monomers containing an acid group, such products being commercially available under the tradename Amphomer® or Amphomer® LV-71, supplied by NATIONAL STARCH, USA.

Other examples of suitable hair-fixing polymers are the copolymers of acrylic acid, methyl acrylate and methacrylamidopropyltrimethylammonium chloride (INCI designation: Polyquaternium-47), the copolymers of acrylamidopropyltrimethylammonium chloride and acrylates, copolymers of acrylamide, acrylamidopropyltrimethylammonium chloride, 2-amido-propylacrylamide sulfonate and dimethylaminopropylamine (INCI designation: Polyquaternium43) or the chitosans. Also suitable are polymers with betaine group-bearing monomers such as, for example, the copolymers of metacryloylethylbetaine and two or more monomers selected from among acrylic acid or the simple esters thereof, known under the INCI designation methacryloylethylbetaine/acrylates copolymer.

Suitable cationic polymers are polymers containing cationic groups, preferably quaternary ammonium groups or imminium groups or cation-active groups, preferably primary, secondary or tertiary amino groups. Suitable cationic polymers preferably contain quaternary ammonium groups. The cationic polymers can be homopolymers or copolymers, with the quaternary nitrogen groups being contained either in the polymer chain or preferably as substituents in one or more of the monomers. The ammonium groups-containing monomers can be copolymerized with noncationic monomers. Suitable cationic monomers are unsaturated, free-radical-polymerizable compounds containing at least one cationic group, particularly ammonium-substituted vinyl monomers, for example trialkylmethacryloxyalkylammonium, trialkylacryloxyalkylammonium, dialkyldiallylammonium and quaternary vinylammonium monomers with cyclic, cationic nitrogen-containing groups such as pyridinium, imidazolium or quaternary pyrrolidone, for example alkylvinylimidazolium, alkylvinylpyridinium or alkylvinylpyrrolidone salts. The alkyl groups of these monomers are preferably the lower alkyl groups, for example C₁- to C₇-alkyl groups and more preferably C₁- to C₃-alkyl groups. The ammonium groups-containing monomers can be copolymerized with noncationic monomers. Suitable comonomers are, for example, acrylamide, methacrylamide, alkylacrylamide and dialkylacrylamide, alkylmethacrylamide and dialkylmethacrylamide, alkyl acrylate, alkyl methacrylate, vinylcaprolactone, vinylcaprolactam, vinylpyrrolidone, vinyl esters, for example vinyl acetate, vinyl alcohol, propylene glycol or ethylene glycol, the alkyl groups of these monomers preferably being C₁- to C₇-alkyl groups and more preferably C₁- to C₃-alkyl groups.

Cationic polymers with quaternary amine groups are, for example, the polymers described in the CTFA Cosmetic Ingredient Dictionary under the designation Polyquaternium, such as methylvinylimidazolium chloride/vinylpyrrolidone copolymer (Polyquaternium-16) or quaternized vinylpyrrolidone/dimethylaminoethyl methacrylate copolymer (Polyquaternium-11) and the quaternary silicone polymers or oligomers, for example, the silicone polymers with quaternary end groups (Quatemium-80). Suitable among the cationic polymers is, for example, the vinyl pyrrolidone/dimethylaminoethyl methacrylate methosulfate copolymer, marketed under the tradenames Gafquat® 755 N and Gafquat® 734 and of which Gafquat® 755 N is particularly preferred. Other cationic polymers are, for example, the copolymer of polyvinylpyrrolidone and imidazolimine methochloride marketed under the tradename LUVIQUAT® HM 550, the terpolymer of dimethyldiallylammonium chloride, sodium acrylate and acrylamide marketed under the tradename Merquat® Plus 3300, the terpolymer of vinylpyrrolidone, dimethylaminoethyl methacrylate and vinylcaprolactam marketed under the tradename Gaffix® VC 713 and the vinylpyrrolidone/methacrylamidopropyltrimethylammonium chloride copolymer marketed under the tradename Gafquat® HS 100.

Suitable cationic polymers derived from natural polymers are the cationic derivatives of polysaccharides, for example cationic derivatives of cellulose, starch or guar. Also suitable are chitosan and chitosan derivatives. Cationic polysaccharides have the general formula
G-O—B—N⁺R⁵R⁶R⁷ X⁻
wherein G stands for an anhydroglucose group, for example starch anhydroglucose or cellulose anhydroglucose;

B is a divalent linking group, for example alkylene, oxyalkylene, polyoxyalkylene or hydroxyalkylene;

R⁵, R⁶ and R⁷ independently of each other stand for alkyl, aryl, alkylaryl, arylalkyl, alkoxyalkyl or alkoxyaryl in each case with up to 18 carbon atoms, the total number of carbon atoms in R⁵, R⁶ and R⁷ preferably amounting to a maximum of 20;

X⁻ is an anion, for example halogen, acetate, phosphate, nitrate or alkylsulfate and preferably chloride. A cationic cellulose is marketed by Amerchol under the designation Polymer JR and bears the INCI designation Polyquaternium-10. Another cationic cellulose bears the INCI designation Polyquaternium-24 and is marketed by Amerchol under the tradename Polymer LM-200. A suitable cationic guar derivative is marketed under the tradename Jaguar® R and has the INCI designation guar hydroxypropyltrimonium chloride. Particularly preferred cation-active substances are chitosan, chitosan salts and chitosan derivatives. The chitosans for use according to the invention are completely or partly deacetylated chitins. The molecular weight of the chitosan can be distributed over a wide range, for example from 20,000 to about 5 million g/mol. Suitable is, for example, a low-molecular-weight chitosan with a molecular weight of 30,000 to 70,000 g/mol. Preferably, however, the molecular weight is greater than 100,000 g/mol and more preferably 200,000 to 700,000 g/mol. The degree of deacetylation is preferably 10 to 99% and more preferably 60 to 99%. A suitable chitosan is marketed, for example, by Kyowa Oil & Fat, Japan, under the tradename Flonac®. It has a molecular weight of 300,000 to 700,000 g/mol and is 70 to 80% deacetylated. A preferred chitosan salt is chitosonium pyrrolidonecarboxylate marketed, for example, under the designation Kytamer® PC. The chitosan it contains has a molecular weight of about 200,000 to 300,000 g/mol and is 70 to 85% deacetylated. Suitable chitosan derivatives are quaternized, alkylated or hydroxyalkylated derivatives, for example hydroxyethylhy-, droxypropyl- or hydroxybutylchitosan. The chitosans or chitosan derivatives are preferably in eutralized or partly neutralized form. The degree of neutralization of the chitosan or chitosan derivatives is preferably at least 50% and most preferably between 70 and 100%, based on the number of free basic groups. In principle, the neutralizing agent can be any cosmetically tolerated inoganic or organic acid, for example formic acid, malic acid, lactic acid, pyrrolidonecarboxylic acid, hydrochloric acid etc, among which pyrrolidonecarboxylic acid and lactic acid are particularly preferred.

Suitable hair-fixing polymers are, in particular: vinylpyrrolidone/dimethylaminoethyl methacrylate copolymer, Styleze CC-10, PVP/DMAPA acrylates copolymer, terpolymers of vinylpyrrolidone, vinylcaprolactam and 3-(N-dimethylaminopropyl)methacrylamide, Gasquat 734 or 755N, Quaternium-23, Gantrez ES 425, the butyl ester of PVM/MA copolymer, polyvinylpyrrolidone, Flexan 130, a sodium polystyrenesulfonate, Amphomer 28-4910, an octylacrylamide/acrylates/butylamino methacrylate copolymer, Amphomer LV-71, octylacrylamide/acrylates/butylaminoethyl methacrylate copolymer, Balance 0/55, a methacrylate polymer, Versatyl 42, an acrylates/octylacrylamide copolymer, Resyn 28-2930, a VA/crotonates/vinyl neodecanoate copolymer, Lovocryl-47, an octylacrylamide/acrylates/butylaminoethyl methacrylate copolymer, Amaze Starch Polymer, polyether-polyurethanes, polyurethanes, for example Luviset PUR, acrylate copolymers, acrylamide copolymers, acrylamide/sodium acrylate copolymers, acrylate/ammonium methacrylate copolymer, adipic acid/dimethylaminohydroxypropyldiethylenetriamine copolymer, adipic acid/epoxypropyidiethylenetriamine copolymer, allyl stearate/VA copolymer, AMP acrylate/diacetoneacrylamide copolymers, AMPD acrylate/diacetoneacrylamide copolymers, ethyl-, isopropyl- or butyl ester of PVM/MA copolymer, PVM/MA copolymer, cornstarch/acrylamide/sodium acrylate copolymer, diethylene glycolamine/epichlorohydrin/piperazine copolymer, diethylene glycol/cyclo-hexanedimethanol/isophthalates/sulfoisophthalates copolymer (for example AQ 55S Polymer), diethylene glycol/isophthalates/sulfoisophthalates copolymer (for example, AQ 29S Polymer), dodecanedioic acid/Cetearyl alcohol/ethylene glycol copolymer, graft-copoly(dimethylsiloxane isobutyl methacrylate), graft-copoly(IBMA/MEFOSEA/PDMS), methacryloylethylbetaine/methacrylate copolymers, octylacrylamide/acrylate/butylaminoethyl methacrylate copolymers, octylacrylamide/-acrylate copolymers, phthalic anhydride/glycerol/glycidyl decanoate copolymer, phthalic anhydride/trimellitic anhydride/ethylene glycol copolymers, polyacrylamide, polyacrylamidomethylpropanesulfonic acid, polybutylene terephthalate, polyethyl acrylate, polyethylene, polymethacrylamidopropyltrimonium chloride, Polyquaternium-1, Polyquaternium-2-, Polyquaternium-4, Polyquaternium-5, Polyquaternium-6, Polyquaternium-7, Polyquaternium-8, Polyquaternium-9, Polyquaternium-10, Polyquaternium-11, Polyquaternium-12, Polyquaternium-13, Polyquaternium-14, Polyquaternium-15, Polyquaternium-16, Polyquaternium-24, Polyquaternium-28, Polyquaternium-37, Polyquaternium-46, polyvinyl acetate, polyvinyl butyral, polyvinylimidazolinium acetate, polyvinyl methyl ether, PVM/MA copolymer, PVP, PVP/acrylates copolymer, PVP/dimethylaminoethyl methacrylate copolymer, PVP/eicosene copolymer, PVP/ethyl methacrylate/methacrylic acid copolymer, PVP/hexadecene copolymer, PVPNA/vinyl propionate copolymer, PVP/vinyl acetate copolymer, PVP/vinyl acetate/itaconic acid copolymer, Quaternium-23, shellac, sodium acrylate/-vinyl vinyl alcohol copolymer, sucrose benzoate/sucrose acetate isobutyrate/butylbenzene phthalate copolymer, styrene/PVP copolymer, sucrose benzoate/sucrose acetate isobutyrate/butylbenzyl phthalate/methyl methacrylate copolymer, sucrose benzoate/sucrose acetate isobutyrate copolymer, tricontanyl PVP, vinyl acetate/crotonates copolymers, vinyl acetate/crotonic acid copolymer, vinyl acetate/butyl maleate/isobornyl acetate copolymer, vinyl acetate/crotonic acid/methacryloxybenzophen-1-one copolymer, vinyl acetate/crotonic acid/vinyl neodecanoate copolymer, vinylcaprolactam/PVP/dimethylaminoethyl methacrylate copolymer and mixtures thereof.

Solvents

The agent of the invention is preferably packaged in an aqueous or aqueous-alcoholic medium preferably containing at least 50 wt. % of water and preferably at the most 40 wt. % of alcohol. Suitable alcohols are the low monohydric alcohols with 1 to 4 carbon atoms usually employed for cosmetic purposes, for example ethanol and isopropanol. In a preferred embodiment, the gel contains, particularly for improving the luster of the treated hair, polyhydric alcohols, preferably those with 2 to 6 carbon atoms and with 2 to 6 hydroxyl groups, in an amount from 0.1 to 15 wt. % and preferably from 1 to 10 wt. %. Particularly preferred are glycerol, ethylene glycol and propylene glycol and especially 1,2-propylene glycol and sorbitol. Silicone oils, particularly polydimethylsiloxanes(dimethicones) and aryl-substituted polydimethylsiloxanes (for example phenyltrimethicone), can also be used to improve luster.

Rheology

The viscosity, particularly of the conventional gel-like and pudding-like agents of the invention is preferably from 1000 to 100,000 mPa s and particularly from 2000 to 50,000 mPa s or from 2500 to 15,000 mPa s, determined by dynamic viscosity measurement with a HAAKE-VT550 Rheometer, SV-DIN spindle, at a temperature of 25° C. and at a shear rate of 50 s⁻¹.

Depending on the gel former used and/or the hair-fixing polymer, the use according to the invention of water glass as the neutralizing agent for acidic gel formers makes it possible, in particular, to prepare hair-styling gels having a multiplicity of different consistencies with advantageous, special rheological characteristics, improved application properties and attractive haptic characteristics, something that cannot be achieved by use of, for example, AMP.

In one embodiment, the styling gels have a pudding-like consistency, particularly gels for which the polymeric gel former (A) was selected from among synthetic polymers of itaconic acid monoesters and at least one other monomer (for example acrylates/Ceteth-20 itaconate copolymer), and the hair-fixing polymer (C) was selected from among nonionic polymers, particularly the homopolymers of vinyllactam and copolymers of vinyllactam and at least one other monomer (for example polyvinylpyrrolidone, vinylpyrrolidone/vinyl acetate copolymer). The shear modulus in this case is higher than that observed for neutralization carried out with aminomethylpropanol (2-amino-2-methyl-1-propanol) and a comparable viscosity.

In another embodiment, the styling gels have a crumbly, friable consistency (in the form of flaky particles, rubber-like), similar to that of rice pudding, particularly gels for which the polymeric gel former (A) was selected from among crosslinked or noncrosstinked synthetic homopolymers of acrylic acid (for example carbomer), and the hair-fixing polymer (C) was selected from among the homopolymers of vinyllactam or copolymers of vinyllactam and at least one other monomer; for example vinylpyrrolidone/vinyl acetate copolymer and vinylcaprolactam/vinylpyrrolidone/dimethylaminoethyl methacrylate copolymer.

In a further embodiment, the styling gels have the typical consistency similar to that of conventional carbomer gels with a comparably low shear modulus, particularly gels for which the polymeric gel former (A) was selected from among crosslinked or noncrosslinked synthetic homopolymers of acrylic acid (for example carbomer), and the hair-fixing polymer (C) was selected from among the anionic polymers, particularly the polymers of a crotonic acid monomer and at least one other monomer (for example vinyl acetate/crotonate copolymer).

Pigments

In a particular embodiment, the gel of the invention is suited for the simultaneous fixing and temporary coloring of hair and additionally contains at least one temporary hair-coloring pigment. By temporary hair coloring of human hair is meant a color change that will last to the next hair washing and that can again be removed by washing the hair with a common shampoo. The pigments are preferably used in an amount from 0.01 to 25 wt. %, and more preferably in an amount from 5 to 15 wt. %. The pigments are preferably nanopigments or micropigments. The preferred particle size is 1 to 200 μm, particularly 3 to 150 μm and most preferably from 10 to 100 μm.

The pigments are colorants practically insoluble in the application medium and they can be inorganic or organic. Mixed inorganic-organic pigments can also be used. Preferred are inorganic pigments. Their advantage lies in their excellent light resistance, weathering resistance and heat resistance. The inorganic pigments can be of natural origin, for example prepared from chalk, ocher, umber, green earth, burnt sienna or graphite. The pigments can be white such as, for example, titanium dioxide or zinc oxide, or black such as, for example, black iron oxide, they can be colorful such as, for example, ultramarine or red iron oxide, or they can be lustrous, or produce a metal effect, or they can be nacreous luster pigments or fluorescing or phosphorescing pigments. Preferably, at least one of the pigments is a colored, nonwhite pigment. Suitable are metal oxides, metal hydroxides and metal oxide hydrates, mixed-phase pigments, sulfur-containing silicates, metal sulfides, complex metal cyanides, metal sulfates, metal chromates and metal molybdates as well as the metals themselves (bronze pigments). Particularly well suited are titanium dioxide (CI 77891), black iron oxide (CI 77499), yellow iron oxide (CI 77492), red and brown iron oxide (CI 77491), manganese violet (CI 77742), ultramarine (sodium aluminum sulfosilicates, CI 77007, Pigment Blue 29), chromium oxide hydrate (CI 77289), Prussian blue (ferric ferrocyanide, CI 77510) and carmine (cochineal).

Particularly preferred are pigments based on mica and coated with a metal oxide or a metal oxychloride such as titanium dioxide or bismuth oxychloride and optionally other colored substances such as iron oxides, Prussian blue, ultramarine, carmine etc, it being possible to set the color by varying the coating thickness. Such pigments are marketed, for example, under the tradenames Rona®, Colorona®, Dichrona® and Timiron® by Merck, Germany.

Suitable organic pigments are for example, the natural pigments sepia, gamboge, bone charcoal, Cassel brown, indigo, chlorophyll and other plant pigments. Suitable synthetic organic pigments are, for example, the azo pigments, anthraquinoids, indigoids and the dioxazine, quinacridone, phthalocyanine, isoindolinone, perylene and perinone pigments, the metal complex pigments, alkali blue pigments and diketopyrrolopyrrol pigments.

Additives

The agent of the invention furthermore can contain common additives used for hair-treatment agents, for example wetting agents or emulsifiers from the classes of nonionic, anionic, cationic or amphoteric surfactants, such as fatty alcohol sulfates, alkylbenzenesulfonates, alkyltrimethylammonium salts and alkylbetaines, in an amount from 0.1 to 15 wt. %; moisturizers; perfume oils in an amount from 0.1 to 1 wt. %; opacifiers, for example, ethylene glycol distearate, in an amount from about 0.2 to 5.0 wt. %; nacreous luster-imparting agents, for example a mixture of a fatty acid monoalkylolamide and ethylene glycol distearate, in an amount from about 1.0 to 10 wt. %; bactericidal and fungicidal agents, for example 2,4,4-trichloro-2-hydroxydiphenyl ether or methylchloroisothiazolinone, in an amount from 0.01 to 1.0 wt. %; thickeners, for example coco fatty acid diethanolamide, in an amount from about 0.2 to 3.0 wt. %; buffering substances, for example sodium citrate or sodium phosphate, in an amount from 0.1 to 1.0 wt. %; tinting substances, for example fluorescein sodium salt, in an amount from about 0.1 to 1.0 wt. %; hair-care agents, for example plant and herb extracts, protein hydrolyzates and silk hydrolyzates or lanolin derivatives, in an amount from 0.1 to 5 wt. %; physiologically tolerated silicone derivatives, for example volatile or nonvolatile silicone oils or high-molecular-weight siloxane polymers, in an amount from 0.05 to 20 wt. %; agents for protection from light, antioxidants, free-radical scavengers and antidandruff agents, in amount from about 0.01 to 4 wt. %; fatty alcohols, luster-imparting agents, vitamins, softeners, combability improvers, fat-replacing agents and defoamers.

Application Properties

For hair styling, the agents of the invention can be applied to moist or dry hair. Even the unusual, crumbly or pudding-like consistencies can readily be spread by rubbing in the hand, easily worked into the hair and are to be used as a “normal” gel. The products are suitable for both smooth and curly hair. The variant with a crumbly consistency, in particular, is especially well suited for fine and rather long hair permitting easy, nonsticky hair styling. Also advantageous is the use for accentuation on only part of the hairdo, for example to define strands or model the hair tips. Depending on the consistency, it is possible to attain luster effects known as the “wet effect” or “dirty look”. In particular, creative, modern styling uses are also possible, for example an “out-of-bed look” and a “grunge look”, or the formation of spikes and ropes. The variant with a pudding-like gel consistency, in particular, has a strong adhesive phase and is particularly well suited for light, fine hair. The product is unusually easy to work in, and on the hair is at first soft and flexible and then becomes firm with a good finish effect, individual hair parts can readily be defined, and the product is particularly well suited for creating fringed, voluminous hairdos.

The following examples will explain the subject matter of the invention in greater detail.

### EXAMPLES

Sodium water glass was used as a 30% aqueous solution with a density of 1.37 g/cm³ (20° C.). Unless a commercial product is explicitly indicated, the amounts used refer to the solids content.

### Example 1

### Hair-Styling Agent, “Crumbly” Consistency

| | |
|---|---|
| 1-4 g | of carbomer |
| 0.5-3 g | of sodium water glass |
| 1-8 g | of VP/VA copolymer |
| 2-20 g | of luster-imparting component (dimethicone, glycerol, |
| | propylene glycol, ethylene glycol and/or sorbitol) |
| as needed | perfume, emulsifier, UV absorber |
| to 100 g | water |

### Example 1.1

### Hair-Styling Agent, “Crumbly” Consistency

| | |
|---|---|
| 1.5 g | of carbomer |
| 1 g | of sodium water glass |
| 2 g | of VP/VA copolymer |
| 5 g | of dimethicone |
| 8 g | of propylene glycol |
| as needed | perfume, emulsifier, UV absorber |
| to 100 g | water |

### Example 2

### Hair-Styling Agent, “Crumbly” Consistency

| | |
|---|---|
| 1-4 g | of carbomer |
| 0.5-3 g | of sodium water glass |
| 1-13 g | of Advantage ® LC-E* |
| 2-20 g | of luster-imparting component (dimethicone, glycerol, |
| | propylene glycol, ethylene glycol and/or sorbitol) |
| as needed | perfume, emulsifier, UV-absorber |
| to 100 g | water |

*vinyl caprolactam/VP/dimethylaminoethyl methacrylate copolymer (37%), lauryl-pyrrolidone (0.1%), ethanol (62.9%)

### Example 2.1

### Hair-Styling Agent, Consistency “Crumbly”

| | |
|---|---|
| 1.5 g | of carbomer |
| 1 g | of sodium water glass |
| 2.2 g | of Advantage ® LC-E* |
| 5 g | of dimethicone |
| 8 g | of propylene glycol |
| as needed | perfume, emulsifier, UV absorber |
| to 100 g | water |

*vinyl caprolactam/VP/dimethylaminoethyl methacrylate copolymer (37%), lauryl-pyrrolidone (0.1%), ethanol (62.9%)

### Example 2.2

### Hair-Styling Agent, “Crumbly” Consistency Comparative Tests with Alternative Neutralizing Agents

| | A | | B | | C | | D | |
|---|---|---|---|---|---|---|---|---|
| Carbomer | 2 | g | 2 | g | 2 | g | 2 | g |
| Sodium water glass | 100%*¹ | | — | | — | | — | |
| Aminomethylpropanol (AMP) | — | | 100%*¹ | | — | | — | |
| Aminoethylpropanediol (AEPD) | — | | — | | 100%*¹ | | — | |
| Tromethamine (Tris Amino) | — | | — | | — | | 100%*¹ | |
| Advantage ® LC-E⁺² | 2.7 | g | 2.7 | g | 2.7 | g | 2.7 | g |
| Glycerol | 3 | g | 3 | g | 3 | g | 3 | g |
| Sorbitol | 5 | g | 5 | g | 5 | g | 5 | g |
| Perfume, emulsifier, UV absorber | as | | as | | as | | as | |
| | needed | | needed | | needed | | needed | |
| Water | to 100 | g | to 100 | g | to 100 | g | to 100 | g |

| | | | | |
|---|---|---|---|---|
| Crumbly consistency | + | − | − | − |

| | E | | F | | G | | H | |
|---|---|---|---|---|---|---|---|---|
| Carbomer | 2 | g | 2 | g | 2 | g | 2 | g |
| Tetrahydroxypropylethylenediamine | 100%*¹ | | — | | — | | — | |
| Sodium hydroxide solution | — | | 100%*¹ | | — | | — | |
| Potassium hydroxide solution | — | | — | | 100%*¹ | | — | |
| Ammonia | — | | — | | — | | 100%*¹ | |
| Advantage ® LC-E⁺² | 2.7 | g | 2.7 | g | 2.7 | g | 2.7 | g |
| Glycerol | 3 | g | 3 | g | 3 | g | 3 | g |
| Sorbitol | 5 | g | 5 | g | 5 | g | 5 | g |
| Perfume, emulsifier, UV absorber | as | | as | | as | | as | |
| | needed | | needed | | needed | | needed | |
| Water | to 100 | g | to 100 | g | to 100 | g | to 100 | g |

| | | | | |
|---|---|---|---|---|
| Crumbly consistency | − | − | − | − |

*¹Neutralization-grade Carbomer
⁺²Vinylcaprolactam/VP/dimethylaminoethyl methacrylate copolymer (37%), laurypyrrolidone (0.1%), ethanol (62.9%)

When rather than using water glass the neutralization is carried out with a different neutralizing agent, the desired crumbly consistency is not created.

### Example

### Hair-Styling Agent, “Gel” Consistency

| | |
|---|---|
| 0.5-4 g | of carbomer |
| 0.4-34 g | of sodium water glass |
| 1-8 g | of VA/crotonates copolymer |
| 2-20 g | of luster-imparting component (dimethicone, glycerol, |
| | propylene glycol, ethylene glycol and/or sorbitol) |
| as needed | perfume, emulsifier, UV absorber |
| to 100 g | water |

### Example 3.1

### Hair-Styling Agent, “Gel” Consistency

| | |
|---|---|
| 1.5 g | of carbomer |
| 2.5 g | of sodium water glass |
| 2 g | of VA/crotonates copolymer |
| 5 g | of sorbitol |
| as needed | perfume, emulsifier, UV absorber |
| to 100 g | water |

### Example 4

### Hair-Styling Agent, “Gel” Consistency

| | |
|---|---|
| 0.5-4 g | of carbomer |
| 0.4-3 g | of sodium water glass |
| 1-4 g | of polyvinylpyrrolidone |
| 2-20 g | of luster-imparting component (dimethicone, glycerol, |
| | propylene glycol, ethylene glycol and/or sorbitol) |
| as needed | perfume, emulsifier, UV absorber |
| to 100 g | water |

### Example 4.1

### Hair-Styling Agent, “Gel” Consistency

| | |
|---|---|
| 0.5 g | of carbomer |
| 0.4 g | of sodium water glass |
| 3 g | of Polyvinylpyrrolidone K 85 |
| 5 g | of dimethicone |
| 8 g | of propylene glycol |
| as needed | perfume, emulsifier, UV absorber |
| to 100 g | water |

### Example 5

### Hair-Styling Agent, “Pudding” Consistency

| | |
|---|---|
| 1-8 g | of VP/VA copolymer |
| 0.5-3 g | of sodium water glass |
| 3-10 g | of acrylates/Ceteth-20 itaconate copolymer |
| 1-10 g | of luster-imparting component (dimethicone, glycerol, |
| | propylene glycol, ethylene glycol and/or sorbitol) |
| as needed | perfume, emulsifier, UV absorber |
| to 100 g | water |

### Example 5.1

### Hair-Styling Agent, “Pudding” Consistency

| | |
|---|---|
| 8 g | of VP/VA copolymer |
| 2 g | of sodium water glass |
| 3 g | of acrylates/Ceteth-20 itaconate copolymer |
| 4 g | of propylene glycol |
| as needed | perfume, emulsifier, UV absorber |
| to 100 g | water |

### Example 5.2

### Hair-Styling Agent, “Pudding” Consistency Comparative Tests with Alternative Neutralizing Agents

| | A | | B | | C | | D | |
|---|---|---|---|---|---|---|---|---|
| VP/VA copolymer | 8 | g | 8 | g | 8 | g | 8 | g |
| Sodium water glass | 100%*¹ | | — | | — | | — | |
| Aminomethylpropanol (AMP) | — | | 100%*¹ | | — | | — | |
| Aminoethylpropanediol (AEPD) | — | | — | | 100%*¹ | | — | |
| Tromethamine (Tris Amino) | — | | — | | — | | 100%*¹ | |
| Acrylates/Ceteth-20 itaconate | 3 | g | 3 | g | 3 | g | 3 | g |
| copolymer | | | | | | | | |
| Glycerol | 6 | g | 6 | g | 6 | g | 6 | g |
| Perfume, emulsifier, UV absorber | as needed | | as needed | | as needed | | as needed | |
| Water | to 100 | g | to 100 | g | to 100 | g | to 100 | g |
| Pudding-like gel consistency | + | | − | | − | | − | |
| VP/VA copolymer | 8 | g | 8 | g | 8 | g | 8 | g |
| Tetrahydroxypropylethylenediamine | 100%*¹ | | — | | — | | — | |
| Sodium hydroxide solution | — | | 100%*¹ | | — | | — | |
| Potassium hydroxide solution | — | | — | | 100%*¹ | | — | |
| Ammonia | — | | — | | — | | 100%*¹ | |
| Acrylates/Ceteth-20 itaconate | 3 | g | 3 | g | 3 | g | 3 | g |
| copolymer | | | | | | | | |
| Glycerol | 6 | g | 6 | g | 6 | g | 6 | g |
| Perfume, emulsifier, UV absorber | as needed | | as needed | | as needed | | as needed | |
| Water | to 100 | g | to 100 | g | to 100 | g | to 100 | g |

| | | | | |
|---|---|---|---|---|
| Pudding-like gel consistency | − | − | − | − |

*¹Neutralization-grade acrylates/Ceteth-20 itaconate copolymer

When rather than using water glass the neutralization is carried out with a different neutralizing agent, the desired pudding-like gel consistency is not created.

1. Hair-treatment agent containing
(A) at least one acid-groups-containing polymeric gel former,
(B) water glass,
(C) at least one hair-fixing polymer and
(D) water, said hair-treatment agent being in the form of a thickened preparation.

2. Agent as defined in claim 1, characterized in that the polymeric gel former (A) is present in an amount from 0.01 to 10 wt. % and the hair-fixing polymer (C) in an amount from 0.1 to 20 wt. % and that the water content is at least 50 wt. %.

3. Agent as defined in claim 1, characterized in that the polymeric gel former is a crosslinked or noncrosslinked synthetic polymer and is derived from at least one kind of monomer selected from among acrylic acid, methacrylic acid, itaconic acid monoesters, acrylamidoalkylsulfonic acids and/or methacrylamidoalkylsulfonic acids or that the polymeric gel former (A) is an acid-groups-containing polymer of natural origin.

4. Agent as defined in claim 1 characterized in that the hair-fixing polymer (C) is selected from among polyvinylpyrrolidone, polyvinylcaprolactam, polyacrylamide, vinylpyrrolidone/vinyl acetate copolymer, crosslinked or noncrosslinked vinyl acetate/crotonic acid copolymers, terpolymers of vinylpyrrolidone, vinyl acetate and vinylalkanoate, terpolymers of vinyl acetate, crotonate and vinylalkanoate, partly esterified copolymers of vinyl methyl ether and maleic anhydride, copolymers of acrylic acid and/or methacrylic acid and alkyl acrylates, alkyl methacrylates, N-alkylacrylamides, N-alkylmethacrylamides and/or polystyrenesulfonates, copolymers of alkylacrylamide, alkylaminoalkyl methacrylate and two or more monomers selected from among acrylic acid, methacrylic acid or the C₁- to C₄-alkyl esters thereof, with at least one of the monomers having an acid group; copolymers of acrylic acid, methacrylate and methacrylamidopropyltrimethylammonium chloride, copolymers of acrylamidopropylrimethylammonium chloride and acrylates, copolymers of acrylamide, acrylamidopropyltrimethylammonium chloride, 2-amidopropylacrylamide sulfonate and dimethylaminopropylamine, copolymers of methacryloylbetaine and two or more monomers selected from among acrylic acid or the simple esters thereof, methylvinylimidazolium chloride/vinylpyrrolidone copolymer, polyvinylpyrrolidone/dialkylaminoalkyl methacrylate copolymers, quaternized vinylpyrrolidone/dialkylaminoalkyl methacrylate copolymer, homopolymers of dimethyidiallylammonium chloride, copolymers of dimethyidiallylammonium chloride and at least one other monomer, quaternized hydroxyethylcellulose or quaternized guar derivatives, terpolymers of vinylpyrrolidone, vinylcaprolactam and a basic acrylamide monomer of methacrylamide monomer and vinylpyrrolidone/methacrylamidoalkyltrimethylammonium chloride copolymers.

5. Agent as defined in claim 1, characterized in that additionally it contains at least one alcohol selected from among monohydric alcohols with 1 to 4 carbon atoms and polyhydric alcohols with 2 to 6 carbon atoms.

6. Agent as defined in claim 1, characterized in that it has a pH from 5 to 8.5.

7. Agent as defined in claim 1, characterized in that it contains at least one other neutralizing agent besides water glass.

8. Agent as defined in claim 1, characterized in that the polymeric gel former (A) is selected from among crosslinked or noncrosslinked synthetic homopolymers of acrylic acid, and the hair-fixing polymer is selected from among the homopolymers of vinyllactam, copolymers of vinyllactam and at least one other monomer and copolymers of a crotonate and at least one other monomer.

9. Agent as defined in claim 1, characterized in that the polymeric gel former (A) is selected from among synthetic polymers of an itaconic acid ester and at least one other monomer, and the hair-fixing polymer (C) is selected from among the homopolymers of a vinyllactam and copolymers of a vinyllactam and at least one other monomer.

10. Agent as defined in 1 for simultaneously fixing and temporarily coloring hair, characterized in that additionally it contains hair-coloring pigments.

11. Agent as defined in claim 10, characterized in that it contains the pigments in an amount from 0.01 to 25 wt. % and that the pigments are selected from among metal oxides, ultramarine, luster-imparting pigments, metal-effect pigments, nacreous luster-imparting pigments, fluorescent pigments, phosphorescent pigments, metal hydroxides, metal oxide hydrates, mixed-phase pigments, sulfur-containing silicates, metal sulfides, complex metal cyanides, metal sulfates, metal chromates, metal molybdates, bronze pigments, carmine, mica-based pigments coated with a metal oxide or a metal oxychloride or optionally with other color-imparting substances such as iron oxides, Prussian blue, ultramarine, carmine etc and/or the color of which is set by varying the coating thickness.
